(19) United States
(12) Patent Application Publication
(10) Pub. No.: US 2017/0366064 A1
(43) Pub. Date: Dec. 21, 2017

(54) ELECTRIC MOTOR

(71) Applicant: KYB Corporation, Tokyo (JP)

(72) Inventors: Takayuki KAWAGUCHI, Kanagawa (JP); Sayaka UENO, Saitama (JP)

(73) Assignee: KYB Corporation, Tokyo (JP)

(21) Appl. No.: 15/544,569

(22) PCT Filed: Apr. 27, 2016
(86) PCT No.: PCT/JP2016/063282

§ 371 Date: Jul. 19, 2017

(30) Foreign Application Priority Data
Jul. 17, 2015 (JP) 2015-143333

(51) Int. Cl. H02K 5/173; H02K 5/16; H02K 5/02

(52) U.S. Cl. CPC H02K 5/173; H02K 5/02; H02K 5/161

(57) ABSTRACT

An electrical motor includes a stator; a rotor attached to an output shaft and supported within the stator; a cylindrical case housing the stator and the rotor inside; ball bearings rotatably supporting the output shaft; and a second cover member closing an opening of the case, the ball bearing being attached to the second cover member. An outer ring of the ball bearing and the second cover member are integrally formed of resin material.

### TECHNICAL FIELD

The present invention relates to an electric motor.

### BACKGROUND ART

JP 2002-345211A discloses an electric motor that has a rotor rotatably supported by a heat-sink-side bearing also serving as a bracket and by a bracket-side bearing.

### SUMMARY OF INVENTION

However, because the electric motor described in JP 2002-345211A requires fixing work of the bearing to the heat sink using a retaining ring or the like after the bearing is assembled to the heat sink, it takes time to perform an assembling operation.

The present invention has an object to shorten time required for the assembly work of an electric motor.

According to one aspect of the present invention, an electrical motor includes a stator, a rotor attached to an output shaft and supported within the stator, a cylindrical case housing the stator and the rotor inside, a ball bearing rotatably supporting the output shaft, and a cover member closing an opening of the case, the ball bearing being attached to the cover member. An outer ring of the ball bearing and the cover member are integrally formed of resin material.

### BRIEF DESCRIPTION OF DRAWINGS

FIG. 1 is a cross-sectional view of an electric motor according to an embodiment of the present invention; and

FIG. 2 is an enlarged cross-sectional view of a main part of an electric motor according to the embodiment of the present invention.

### DESCRIPTION OF EMBODIMENTS

The following describes an electrical motor 100 according to an embodiment of the present invention with reference to the attached drawings.

The electrical motor 100 is used as a power source for generating steering auxiliary torque, for example, in an electric power steering apparatus.

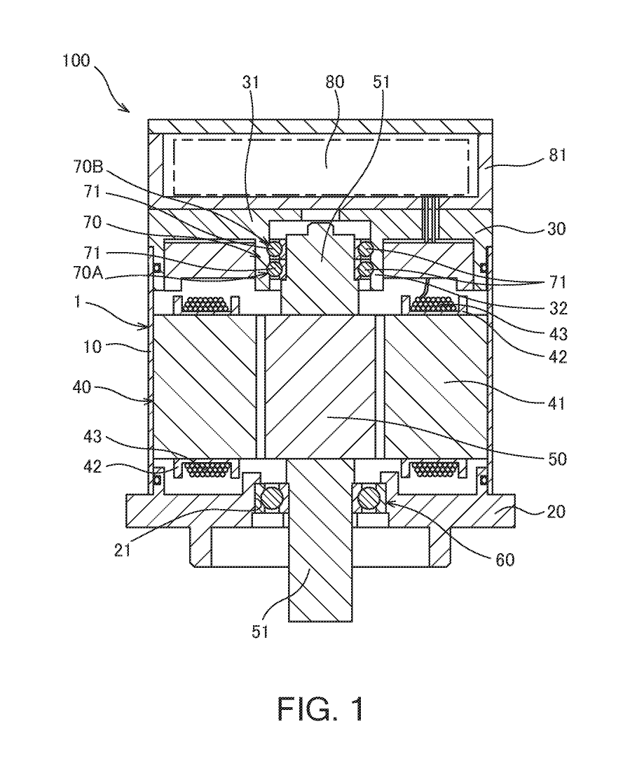

As shown in FIG. 1, the electrical motor 100 includes a case 10 that is formed in a cylindrical shape, a first cover member 20 that closes an opening on one end side of the case 10, and a second cover member 30 that closes an opening on another end side of the case 10. A motor housing 1 is formed by the case 10, the first cover member 20, and the second cover member 30.

A stator 40 is fixed to an inner circumferential surface of the case 10. The stator 40 includes a stator core 41 and a stator coil 43 that is wound around the stator core 41 via an insulator 42.

A cylindrical rotor 50 is provided on an inner periphery of the stator 40 with a slight gap made between the stator 40. The rotor 50 includes an output shaft 51, a rotor core (not shown) that is attached to the output shaft 51, and a permanent magnet (not shown) that is attached to an outer periphery of the rotor core. The output shaft 51 is rotatably supported by ball bearings 60 and 70 that are respectively attached to the first cover member 20 and the second cover member 30. As such, the stator 40 and the rotor 50 are housed and held in the case 10.

The output shaft 51 is projected outside through the first cover member 20 at one end and connected to a steering shaft via a not-illustrated worm reduction mechanism.

The ball bearing 60 that supports the one end side of the output shaft 51 is attached to the first cover member 20. The ball bearing 60 is inserted into a recess 21 that is formed in a central part of the first cover member 20, and held in the recess 21 by a not-illustrated beveled retaining ring. Note that it is not limited the above fixing method, any fixing means such as caulking may be applied as long as the ball bearing 60 is held in the recess 21.

The ball bearing 70 that supports another end side of the output shaft 51 is attached to the second cover member 30. The ball bearing 70 is a double-row ball bearing in which a plurality of ball bearings are disposed in the axial direction of the output shaft 51. Specifically, the ball bearing 70 is constituted of two ball bearings 70A and 70B that are arranged in series in the axial direction of the output shaft 51. The two ball bearings 70A and 70B are provided in the second cover member 30 in a manner that inner rings 72A and 72B come into contact with each other.

A control device 80 that controls electrical signals output to the stator coil 43 is provided on the opposite side of the second cover member 30 from the stator 40 and the rotor 50. The control device 80 is housed in a housing case 81 that is provided adjacent to the second cover member 30. The second cover member 30 and at least a part of the housing case 81 may also be integrated.

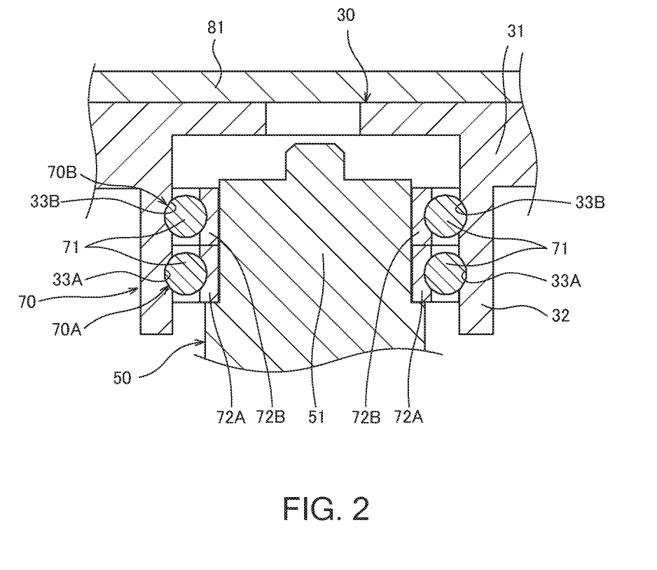

The following describes the second cover member 30 in detail with reference to FIG. 2.

As shown in FIG. 2, the second cover member 30 includes a base body portion 31 that is adjacent to the housing case 81 and a cylindrical portion 32 that projects from the base body portion 31 to the side of the rotor 50. The ball bearing 70 is attached to the cylindrical portion 32. The base body portion 31 and the cylindrical portion 32 are integrally formed of resin material.

As described above, the two ball bearings 70A and 70B are arranged in series on the inner peripheral side of the cylindrical portion 32. The second cover member 30 that is made of resin material has strength weaker than that of a cover member that is made of a metal. However, the two ball bearings 70A and 70B are provided on the second cover member 30 in a manner that the inner rings 72A and 72B come into contact with each other. In this way, a thrust load exerted on the output shaft 51 can be supported by the two ball bearings 70A and 70B, even if a thrust load exerted on the output shaft 51 is large. In other words, because the second cover member 30 is provided with the two ball bearings 70A and 70B constituting a double-row ball bearing in which the two ball bearings 70A and 70B are disposed in series in the axial direction of the output shaft 51, an allowable thrust load of the ball bearing 70 can be increased. Note that the inner rings 72A and 72B may also be integrated. Only either one of the ball bearings 70A and 70B may also be used, if sufficient strength is secured on raceway grooves 33A and 33B.

Outer rings of the ball bearings 70A and 70B are formed integrally with the cylindrical portion 32. Specifically, the annular raceway grooves 33A and 33B are formed on the inner peripheral surface of the cylindrical portion 32. Balls 71 of the ball bearings 70A and 70B respectively roll along the raceway grooves 33A and 33B. In this way, the cylindrical portion 32 that is formed with the raceway grooves 33A and 33B serves as outer rings that support the balls 71 of the ball bearings 70A and 70B.

The second cover member 30 is made of resin material such as POM (polyacetal) and PEEK (polyetheretherketone). Because such materials have excellent sliding property, there is no need for lubricant to be applied between the balls 71, which is made of metal, and the raceway grooves 33A and 33B. This configuration, in which the second cover member 30 is made of resin material, can eliminate the need for maintenance work such as applying lubricant to the ball bearing 70.

The plurality of balls 71 are arranged between the inner rings 72A and 72B and the raceway grooves 33A and 33B, and then, the ball bearings 70A and 70B can be assembled by fixing a not-illustrated retainer that retains the plurality of balls 71. By the above assembly process, the ball bearings 70A and 70B are attached to the second cover member 30. Thus, because the separate fixing work of the ball bearings 70A and 70B to the second cover member 30 is not required after the ball bearings 70A and 70B have been assembled, the simplification of the assembly work and the shortening of the assembly time can be realized.

The case 10 and the second cover member 30 may be formed integrally. In this case, the work for assembling the second cover member 30 and the case 10 may be eliminated.

The foregoing embodiment achieves the following effects.

In the electrical motor 100, the outer rings of the ball bearing 70 and the second cover member 30 are integrally formed of resin material. In this way, the fixing work of the ball bearing 70 to the second cover member 30 is not required, and thus the simplification of the assembly work and the shortening of the assembly time can be realized. A groove for fixing the beveled retaining ring and the like needs not be machined, and thereby, no machining time is required.

Resin material has lower heat conductivity than metal material. Therefore, the second cover member 30 that is made of resin material can prevent heat generated by the stator coil 43 from being transmitted to the control device 80 and can prevent heat generated by the control device 80 from being transmitted to the stator 40 and the rotor 50.

Because the second cover member 30 is made of resin material, weight of the electrical motor 100 can be reduced. Because of the weight reduction, a resonance point shifts to the higher frequency side. Thus, vibration and noise can be suppressed. Furthermore, because resin has elasticity compared to metal, a bias member that biases the rotor 50 in an axial direction may be omitted.

The structures, functions, and effects of the embodiment of the present invention configured as described above will be collectively described below.

The electrical motor 100 includes the stator 40, the rotor 50 that is attached to the output shaft 51 and supported within the stator 40, the cylindrical case 10 that houses the stator 40 and the rotor 50 inside, the ball bearings 60 and 70 that rotatably support the output shaft 51, and the second cover member 30 to which the ball bearing 70 is attached and that closes the opening of the case 10. The outer rings of the ball bearing 70 and the second cover member 30 are integrally formed of resin material.

According to this configuration, because the outer rings of the ball bearing 70 are formed integrally with the second cover member 30, the fixing work of the ball bearing 70 to the second cover member 30 is not required. Thus, the simplification of the assembly work and the shortening of the assembly time can be realized.

The case 10 and the second cover member 30 may be formed integrally in the electrical motor 100.

In this configuration, the assembly work of the second cover member 30 and the case 10 may be eliminated.

Furthermore, in the electrical motor 100, the control device 80 that controls electrical signals output to the stator 40 or the rotor 50 is provided on the opposite side of the second cover member 30 from the stator 40 and the rotor 50.

The second cover member 30 that is made of resin material is located between the control device 80 and the stator 40 and between the control device 80 and the rotor 50. Therefore, the second cover member 30 can prevent heat generated by the stator 40 or the rotor 50 from being transmitted to the control device 80.

Furthermore, the electrical motor 100 has a plurality of ball bearings, and the plurality of ball bearings 70A and 70B are disposed in the axial direction of the output shaft 51 to constitute a double-row ball bearing.

In this configuration, a thrust load exerted on the output shaft 51 can be supported by the two ball bearings 70A and 70B, even if the thrust load exerted on the output shaft 51 is large.

The embodiments of the present invention described above are merely illustration of some application examples of the present invention and not of the nature to limit the technical scope of the present invention to the specific constructions of the above embodiments.

For example, the first cover member 20 and an outer ring of the ball bearing 60 may be integrally formed of resin material in the electrical motor 100. The case 10, the first cover member 20, and the outer ring of the ball bearing 60 may also be integrally formed of resin material in the electrical motor 100.

In the present embodiment, although the electrical motor 100 is a brushless DC motor, a motor with brush or an AC motor may be applied as the electrical motor 100. If the electrical motor 100 is the motor with brush, because a coil is provided in the rotor 50, the control device 80 outputs electrical signals to the rotor 50.

The present application claims a priority based on Japanese Patent Application No. 2015-143333 filed with the Japan Patent Office on Jul. 17, 2015, all the contents of which are hereby incorporated by reference.

1. An electrical motor comprising:
a stator;
a rotor attached to an output shaft and supported within the stator;
a cylindrical case housing the stator and the rotor inside;
a ball bearing rotatably supporting the output shaft; and
a cover member to which the ball bearing is attached, the cover member closing an opening of the case, wherein
an outer ring of the ball bearing and the cover member are integrally formed of resin material.

2. The electrical motor according to claim 1, wherein
the cover member and the case are formed integrally.

3. The electrical motor according to claim 1, further comprising
a control device provided on opposite side of the cover member from the stator and the rotor, the control device being configured to control electrical signals output to the stator or the rotor.

4. The electrical motor according to claim 1, wherein
the electrical motor has a plurality of ball bearings, and the plurality of ball bearings are disposed in an axial direction of the output shaft to constitute a multi-row ball bearing.
